(19) United States
(12) Patent Application Publication
(10) Pub. No.: US 2019/0155335 A1
(43) Pub. Date: May 23, 2019

(54) STYLUS RETAINING ASSEMBLY

(71) Applicant: HEWLETT-PACKARD DEVELOPMENT COMPANY, L.P., HOUSTON, TX (US)

(72) Inventors: PAUL LALINDE, HOUSTON, TX (US); RICHARD LIN, HOUSTON, TX (US); DENEEN SAUNDERS, HOUSTON, TX (US)

(21) Appl. No.: 16/092,937

(22) PCT Filed: Aug. 5, 2016
(86) PCT No.: PCT/US2016/045709

§ 371 Date: Oct. 11, 2018

(51) Int. Cl. G06F 1/16; G06F 3/0488

(52) U.S. Cl. CPC G06F 1/1626; G06F 1/1656; G06F 3/03545; G06F 2200/1632; G06F 3/0488

(57) ABSTRACT

An apparatus includes a substrate to be received into a smart card slot connector of a computing device. The substrate further includes a retainer that is connected to the substrate to hold a stylus such that the stylus is retained to the computing device when the substrate is received in the smart card slot connector.

### BACKGROUND

A pen-shaped instrument, called a “stylus,” may be used as an input device for a portable computing device that has a touchscreen. In this manner, the stylus may be used to interact with the touchscreen for purposes of inputting commands, selecting options presented in a graphical user interface (GUI), scrolling within a window of the GUI, drawing images, and so forth. The stylus may be a passive stylus, which does not contain electronic components. The passive stylus provides input to the computing device by physically contacting the touchscreen. The stylus may be an active stylus that contains electronic components. The active stylus allows input to be communicated to the computing device wirelessly without the stylus physically contacting the touchscreen. Moreover, the active stylus may have other features, such as an electronic eraser, the ability for a user to select stylus options, and so forth.

### BRIEF DESCRIPTION OF THE DRAWINGS

FIG. 1 is a perspective view of a portable computing device, a stylus and a stylus retaining assembly according to an example implementation.

FIG. 2 is a perspective view illustrating the stylus retaining assembly inserted into a smart card slot connector of the portable computing device according to an example implementation.

FIG. 3A is an exploded view of the stylus retaining assembly according to an example implementation.

FIG. 3B is a perspective view of the stylus retaining assembly of FIG. 3A according to an example implementation.

FIG. 4A is an exploded perspective view of a stylus retaining assembly according to a further example implementation.

FIG. 4B is a perspective view of the stylus retaining assembly of FIG. 4A according to an example implementation.

FIGS. 5, 6 and 9 are side views of stylus retaining assemblies according to example implementations.

FIG. 7 is a flow diagram depicting a technique to retain a stylus to a portable computing device according to an example implementation.

FIG. 8 is a perspective view of a stylus retaining assembly according to an example implementation.

### DETAILED DESCRIPTION

A stylus may be to provide input for a computing device that has a touchscreen. In this context, a “stylus” refers to a hand held instrument, having one or multiple ends for interacting with a touchscreen. In accordance with example implementations, the stylus may be in the form of a pen, i.e., an elongated pen-shaped member, which has a pointed end for interacting with the touchscreen. The stylus may or may not have a dedicated end for communicating erase-related input to the computing device.

Depending on the particular implementation, the stylus may be an active stylus, which contains electronic components or a passive stylus that does not contain electronic components. The stylus may be used to provide input to the computing device by physically contacting the touchscreen, hovering over the touchscreen, a user depressing one or multiple buttons of the stylus, and so forth. Moreover, the stylus may be constructed to be used with a variety of touchscreens, such as a capacitive touchscreen, a surface acoustic wave (SAW) touchscreen, a resistive touchscreen, an optical touchscreen, and so forth, depending on the particular implementation.

The computing device may be, in the context of this application, any of a number of processor-based devices, both portable and non-portable. In this manner, the computing device may be relatively easily carried on a person, such as a tablet computer, a notebook computer, a smartphone, a personal digital assistant, and so forth. Moreover, the computing device may be a device that is relatively less portable, such as a desktop computer or a server.

For purposes of keeping the stylus nearby and available for use with the computing device, the stylus may be held, or retained, in an assembly that is mounted to the device. For example, a tablet computer may have a stylus holder that is permanently affixed to the side face of the tablet computer's housing and is constructed to retain the stylus when the stylus is pressed into the stylus holder. Such a holder, however, may occupy the limited space on the tablet computer available for buttons, serial ports, slot connectors, and so forth.

In accordance with example implementations that are described herein, a stylus retaining assembly holds a stylus and is constructed to be inserted into a card slot connector of a computing device for purposes of securing the stylus to the computing device. Moreover, in accordance with example implementations, the stylus retaining assembly may contain an electronic component-containing card that is constructed to be inserted into a card slot connector. The card may be mechanically retained in the slot connector to hold the stylus retaining assembly to the computing device, and the card may be constructed to form electrical connections with the computing device so that the card's electronic components may communicate with the computing device's electronic components to perform one or multiple functions unrelated to retaining the stylus to the computing device.

More specifically, in accordance with example implementations, the stylus retaining assembly is constructed to be retained by a smart card slot connector of the computing device. The stylus retaining assembly may contain a smart card that is constructed to be received in the smart card slot connector and form electrical connections with the computing device when received in the slot connector.

The smart card, in accordance with example implementations, may store data that may be used by the computing device to authenticate a human user (the person possessing the stylus retaining assembly, for example) for purposes of controlling access to resources of the computing device. More specifically, the smart card may contain a microprocessor, and the smart card may contain a memory that stores data (one or multiple digital certificates, for example) for authenticating the user of the computing device. In this manner, a user of the computing device may, for example, supply login and password credentials to a dialog box on the touchscreen and also possess the smart card, which contains one or multiple digital certificates that authenticate the user. Therefore, by supplying the login and password credentials and inserting the smart card in the device's smart card slot connector, the user may be authenticated by the computing device. Thus, in accordance with example implementations, the stylus retaining assembly may be used to perform at least two functions: 1. retain a stylus to the computing device; and 2. provide data to authenticate a user of the computing device.

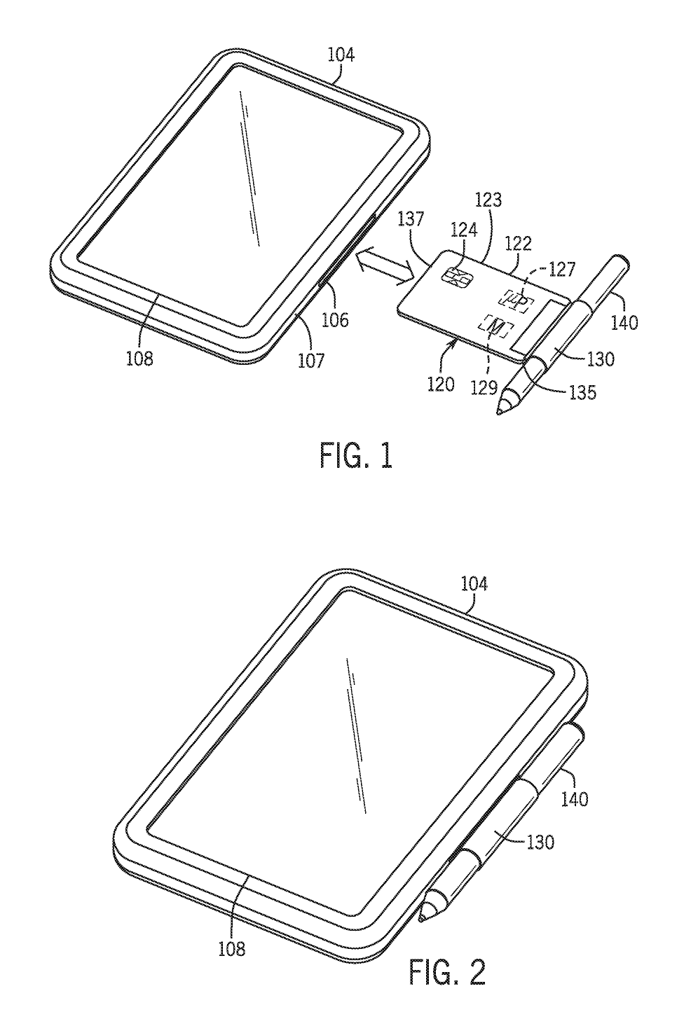

Referring to FIGS. 1 and 2, in accordance with some implementations, the computing device may be a tablet computer 104, which, among its other features, has a touchscreen 108 (a capacitive touchscreen, a resistive touchscreen, a SAW touchscreen, an optical touchscreen, and so forth) and a smart card slot connector 106 that is constructed to receive a smart card. As depicted by the bidirectional arrow of FIG. 1, the stylus retaining assembly 120 may be inserted into and removed from the slot connector 106. FIG. 2 depicts the stylus retaining assembly 120 when fully inserted into the smart card slot connector 106.

Referring to FIG. 1 in conjunction with FIG. 2, the stylus retaining assembly 120, in accordance with example implementations, is constructed to hold a stylus 140 so that when the stylus retaining assembly 120 is fully inserted into the smart card slot connector 106 (FIG. 2), the stylus 140 is secured in place on the side edge, or face 107 (FIG. 1), of the tablet computer 104. In accordance with example implementations, a user may, while the stylus retaining assembly 120 remains inserted in the smart card slot connector 106, remove the stylus 140 from the stylus retaining assembly 120, use the stylus 140 to provide input to the tablet computer 104 and thereafter place the stylus 140 back in the stylus retaining assembly 120.

In accordance with example implementations, the stylus retaining assembly 120 includes a smart card 122 (FIG. 1). The smart card 122, in turn, contains circuitry that is attached (adhered by an adhesive, for example) to a substrate 123 of the smart card 122. As an example, the circuitry may include a microprocessor 127, a memory 129, and so forth. Moreover, the smart card 122 includes exposed electrical contacts 124 for purposes of communicating power and electrical signals with circuitry of the tablet 104 due to the contacts 124 physically contacting corresponding contacts (not shown) inside the smart card slot connector 106. It is noted that FIG. 1 is a schematic view, as the electrical contacts 124, the microprocessor 127 and the memory 129 may be fabricated as a unit that is mounted in a recess of the substrate 123, in accordance with example implementations.

In accordance with example implementations, the smart card 122 may comply with the International Organization for Standardization (ISO)/International Electrotechnical Commission (IEC) 7816 standard for electronic identification cards.

The stylus retaining assembly 120, in accordance with example implementations, is constructed to hold the stylus 140 in a manner that secures the stylus 140 to the assembly 120 (and tablet computer 104), and allows the stylus to be removed from the assembly 120 when a user exerts a sufficient removal force on the stylus 140 without removing the assembly 120 from the card slot connector 106. More specifically, in accordance with example implementations, the stylus retaining assembly 120 includes a flexible retainer (also called a “stylus holder”) to hold the stylus, such as a loop, or tubular member 130. The tubular member 130 circumscribes a longitudinal axis 131 for purposes of forming a right circular cylinder that has an inner diameter that is smaller than the outer diameter of the stylus 140. The tubular member 130 may be constructed from a flexible material (a flexible polyurethane, for example), which allows the tubular member 130 to radially expand when the stylus 140 is inserted into the tubular member 130 along the longitudinal axis 131 for purposes of creating a retention force to retain the stylus 140 inside the tubular member 130.

As depicted in FIG. 1, the smart card substrate 123 may be a generally planar substrate that has a leading edge 137 that inserted into the slot connector 106 and a trailing edge 135 that is secured to the tubular member 130. Moreover, the smart card substrate 123 may be elongated between the leading 137 and trailing 135 edges.

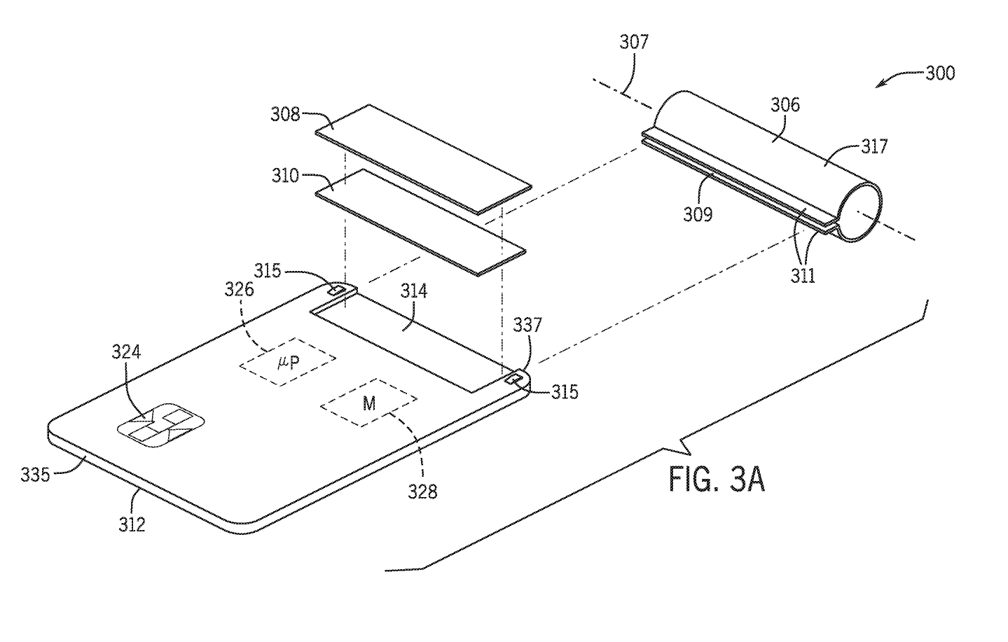

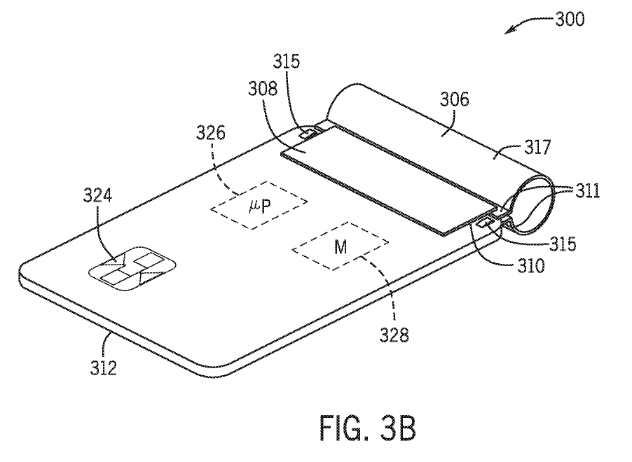

The stylus retaining tube 130 may be mounted to the smart card substrate 123 using a number of different mounts, depending on the particular implementation. For example, referring to FIGS. 3A (depicting an exploded perspective view) and 3B (depicting a perspective view), in accordance with some implementations, a stylus retaining assembly 300 includes a tubular member 306, which functions as a stylus holder, or retainer, that is mounted to a card substrate 312. The tubular member 306 may be formed from polyurethane, in accordance with example implementations, which allows the tubular member 306 to flex or expand to receive and retain a stylus.

In accordance with example implementations, the card substrate 312 has a trailing edge 337 that is mounted to the tubular member 306 and a leading edge 335 that is received first in a smart card slot connector when the stylus retaining assembly 300 is inserted into the connector.

In accordance with example implementations, the card substrate 312 may comply with the ISO/IEC 7816 standard, and in accordance with example implementations, the card substrate 312 may be part of a smart card that has electrical contacts 324, a microprocessor 326, a memory 328 and other features that comply with the ISO/IEC 7816 standard.

In accordance with further example implementations, the card substrate 312 complies with the ISO/IEC 7816 standard. However, the card substrate may be part of a “dummy” smart card, which does not contain other features of a smart card, such as the electrical contacts 324, the microprocessor 326, the memory 328 and so forth. In accordance with further example implementations, the tubular member 306 may be mounted to a card substrate of a dummy smart card that partially complies with the ISO/IEC 7816. For example, the card substrate may have the width of an ISO/IEC 7816 standard card. However, the card substrate may have a length that is shorter than an ISO/IEC 7816 standard card (the card substrate may be one half of the ISO/IEC 7816 standard card length, for example).

As depicted in FIG. 3A, in accordance with example implementations, the tubular member 306 includes a slotted tube 317 that is elongated along a longitudinal axis 307 and has a C-shaped cross-section. In general, the slotted tube 317 circumscribes the longitudinal axis 307, except for a longitudinal slit, or opening 309, in the slotted tube 317. In accordance with example implementations, the tubular member 306 includes parallel mounting flanges 311 that are integral with the slotted tube 317 and extend on either side of the opening 309 to receive a recessed region 314 of the trailing edge 337 of the card substrate 312 in between.

In accordance with example implementations, the tubular member 306 may be secured to the card substrate 312 using an adhesive layer 310 and a flexible fabric material 308. In accordance with some implementations, the flexible fabric material 308 may be a microfelt. As depicted in FIG. 3A, the adhesive layer 310 may be placed in the recessed region 314 of the card substrate 312, such that the adhesive layer 310 contacts the smart card substrate 312 and the flange 311 that extends above the smart card substrate 312. The flexible fabric material 308 is complementarily received in the recessed region 314 on top of the adhesive layer 310. Thus, the adhesive layer 310 may be used to bond the tubular member 306 to the card substrate 312. Moreover, due to the recessed region 314, the top surface of the flexible material 308 may, in accordance with example implementations, be flush or almost flush with the top surface of the card substrate 312.

In accordance with example implementations, the opposite, or bottom, side (not shown) of the card substrate 312 may have a recessed region (not shown), an adhesive layer 310 and a flexible fabric material 308, similar to what is shown in FIG. 3A for the top side of the card substrate 312.

The stylus retaining assembly 300 may include one or multiple detents, or protuberances 315, near the trailing edge 337 for purposes of retaining the assembly 300 inside the slot connector. For the example implementation of FIGS. 3A and 3B, the stylus retaining assembly 300 includes protuberances 315 on either side of the fabric material 308. Moreover, in accordance with example implementations, the protuberances 315 may be integrated with the card substrate 312 (formed in the same mold and from the same material as the substrate 312, for example) and contact the chassis of the computer inside the slot connector to resist removal of the stylus retaining assembly 300 from the slot connector.

In accordance with further example implementations, the adhesive layer 310 may be replaced with a double-sided adhesive tape to form an assembly that may be secured to the smart card substrate 312 by the end user. In this manner, the adhesive on one side of the adhesive tape may be secured to the flexible fabric material 308 and one of the flanges 311, and the other side of the tape may be initially covered by a protective film, or layer. In this manner, a stylus retaining assembly including the tubular member 306, the flexible fabric material 308 and the adhesive tape may be provided as a product so that a user may remove the protective film to adhere the stylus retaining assembly to a smart card that is being used by the user.

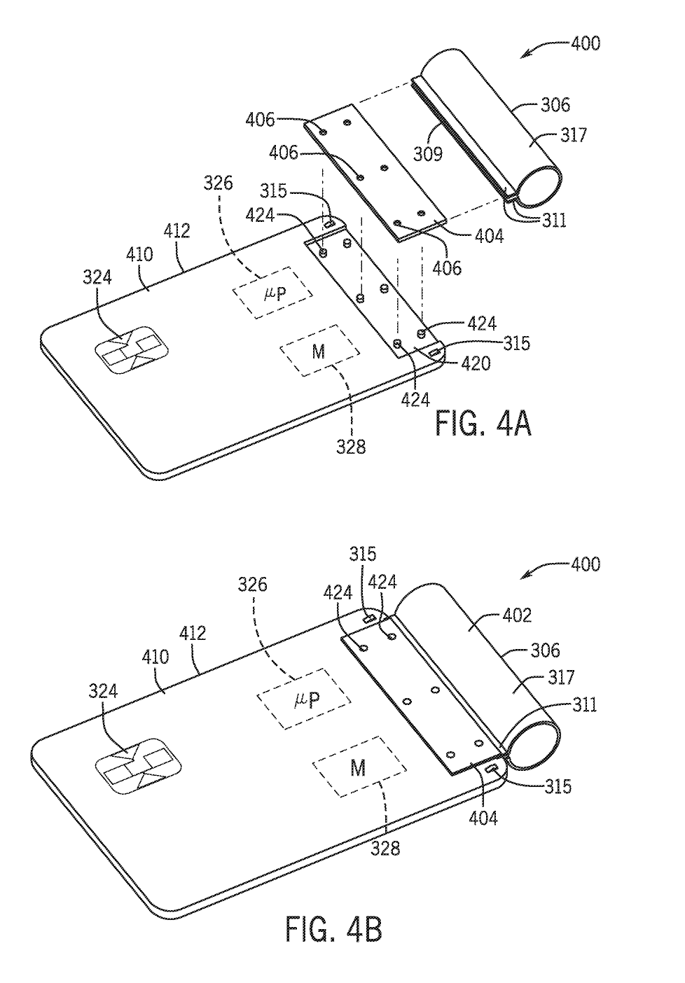

FIG. 4A depicts a stylus retaining assembly 400 in accordance with a further example implementation. The stylus retaining assembly 400 has features similar to the stylus retaining assembly 300, with like reference numerals being used to denote similar components. However, unlike the stylus retaining assembly 300, the stylus retaining assembly 400 uses heat stakes 424 to mount the tubular member 306 to a smart card substrate 410 of a smart card 412. More specifically, in accordance with example implementations, a stylus retaining assembly 400 includes the tubular member 306, a flexible fabric material 404 (a microfelt, for example), the smart card substrate 410 and heat stakes 424. The heat stakes 424 may be formed as part of the smart card substrate 410 and may orthogonally extend from the planar substrate 410, as depicted in FIG. 4A. More specifically, as depicted in FIG. 4A, the heat stakes 424 may extend from a recessed portion 420 of the card substrate 410, which is sized to complimentarily receive the flexible material 404. For this implementation, the material 404 contains openings 406 through which the heat stakes 424 extend. In accordance with example implementations, the card substrate 410 may be heated to cause the upper ends of the heat stakes 424 to partially deform, or melt, to secure the material 406 (and thus, secure the tubular member 306) to the card substrate 410, as illustrated in FIG. 4B.

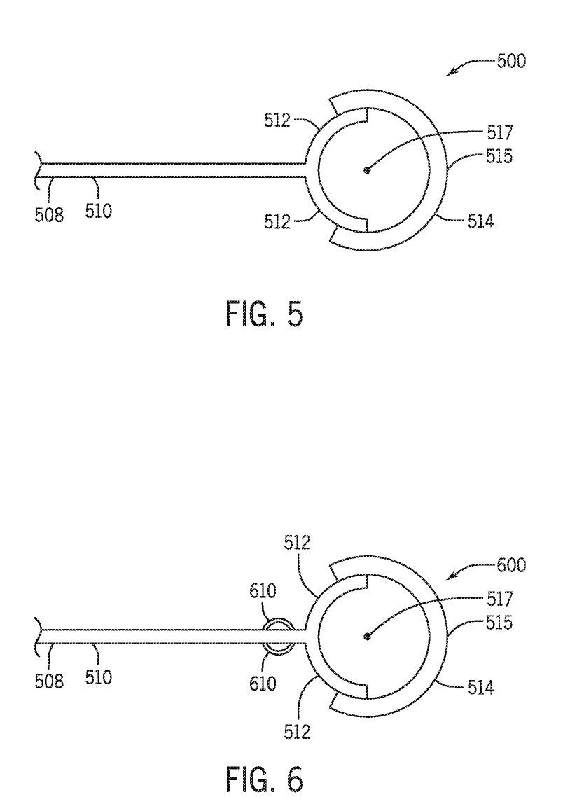

Referring to FIG. 5, in accordance with a further example implementation, a stylus retaining assembly 500 includes a smart card 508, which includes a smart card substrate 510 that has features to form part of a tubular, stylus holder, or retainer. More specifically, as illustrated in FIG. 5, in accordance with example implementations, the substrate 510 includes forked, curved prongs 512, which partially circumscribe a longitudinal axis 517 of a stylus retaining tube 515. The additional portion of the stylus retaining tube 515 is formed from a curved material 514, which partially extends over the curved prongs 512, as illustrated in FIG. 5.

In accordance with further example implementations, the stylus retaining assembly may not include any detent features, such as the protuberances 315 (see FIG. 3A), to retain the smart card substrate inside the smart card slot connector. In accordance with further example implementations, the stylus retaining assembly may have a card retaining detent that is not formed as part of the card substrate. For example, referring to FIG. 6, in accordance with further example implementations, a stylus retaining assembly 600 may have features similar to the assembly 500 of FIG. 5, with similar reference numerals being used to denote these similar features. Unlike the stylus retaining assembly 500 of FIG. 5, however, the stylus retaining assembly 600 includes one or multiple spring members 610 (two spring members 610 being depicted in FIG. 6). The spring member 610 extends from the smart card substrate to engage a chassis of the computing device when the smart card is inserted into the slot connector for purposes of creating a retention force to retain the card substrate in the slot connector. As illustrated in FIG. 6, in accordance with some implementations, the spring member 610 may be a leaf spring formed from an elongated member that is bowed, as depicted in FIG. 6, although other springs and other card retention mechanisms may be used, in accordance with further implementations. Moreover, the spring member 610 or other retention member may be used in conjunction with the protuberance 315, in accordance with further example implementations.

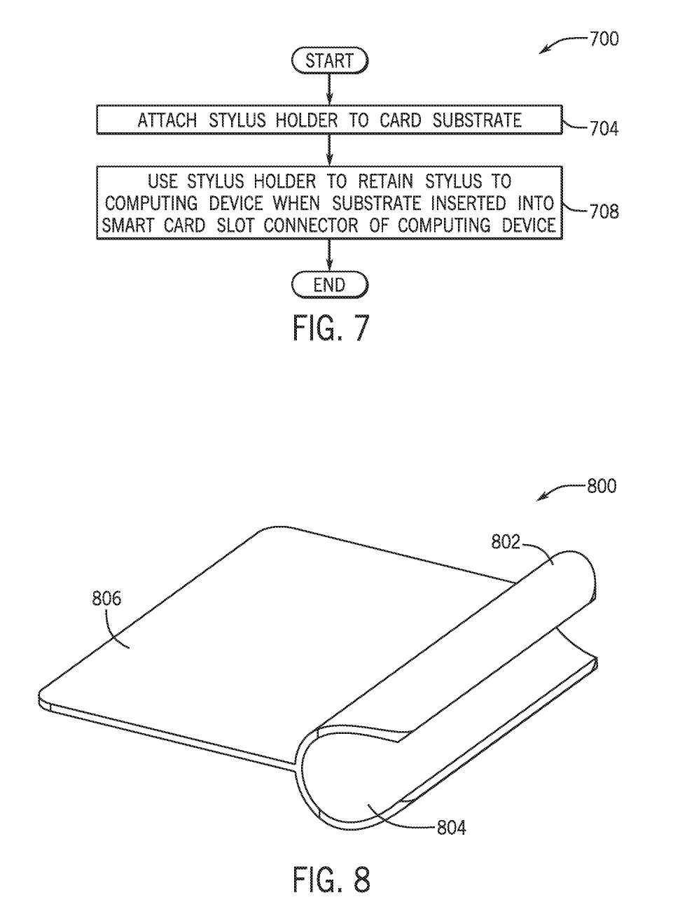

Thus, referring to FIG. 7, in general, in accordance with example implementations, a technique 700 to retain a stylus to a computing device includes attaching (block 704) a stylus holder to a card substrate and using (block 708) the stylus holder to retain a stylus to a computing device when the substrate is inserted into a smart card slot of the computing device.

Other implementations are contemplated, which are within the scope of the appended claims. For example, referring to FIG. 8, in accordance with example implementations, a stylus retaining assembly 800 includes a smart card substrate 806 and a C-shaped stylus holder 802 that has a longitudinally extending opening 804 to receive a stylus. In accordance with example implementations, the stylus holder 802 may have an inner radius of curvature that is slightly smaller than the outer radius of curvature of the stylus to cause the stylus holder 802 to flex when the stylus is inserted into holder 802. In accordance with example implementations, the smart card substrate 806 and the stylus holder 802 may be integrated together and may be, for example, formed from a plastic or flexible polyurethane.

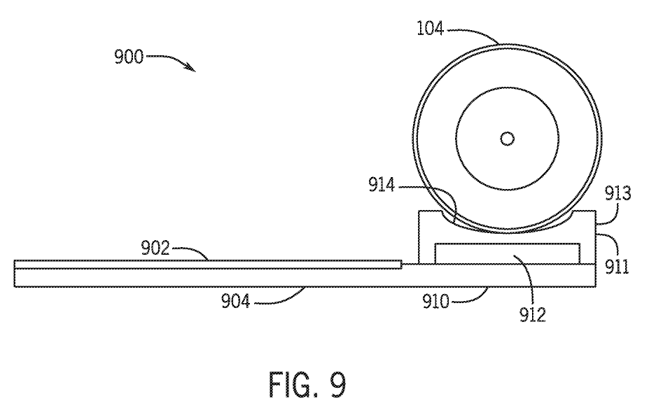

As another example, FIG. 9 depicts a stylus retaining assembly 900, which includes a magnet assembly 913 to hold the stylus 104. For this implementation, it may be assumed that the stylus 104 contains a ferromagnetic material. In accordance with example implementations, the magnet assembly 913 contains a magnet 912 that is embedded in a curved holder 911 of the assembly 913. In accordance with example implementations, the curved holder 911 may be formed from a plastic material. The curved holder 911 includes a curved surface 914 for receiving the stylus 104. Due to the attractive force on the stylus that is provided by the magnet 912, the stylus 104 is retained to the magnet assembly 913 (and thus, retained to the stylus retaining assembly 900). In accordance with example implementations, the magnet assembly 913 may be secured (glued, stitched, and so forth) to a fabric material 904 (a microfelt, for example) of the assembly 900, and an adhesive layer 902 may be used to secure the fabric material 904 to a smart card substrate (not shown in FIG. 9).

In accordance with further example implementations, the adhesive layer 902 may be replaced with a double sided tape. In this manner, in accordance with example implementations, with this modification, the assembly that is depicted in FIG. 9 may be provided as a product for a user to adhere to a smart card. A first side of the double sided tape may be bonded to the fabric material 904, and the other side of the double sided tape may be covered by a protective film, which may be removed by the user for purposes of attaching the assembly to the user's smart card.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a substrate to be received into a smart card slot connector of a computing device; and
a retainer connected to the substrate to hold a stylus such that the stylus is retained to the computing device when the substrate is received in the smart card slot connector.

2. The apparatus of claim 1, wherein the retainer comprises:
a first material to form a tube to hold the stylus;
a second material to attach to the first material;
an adhesive to secure the second material to the substrate.

3. The apparatus of claim 2, wherein the first material comprises a polyurethane, and the second material comprises a microfelt.

4. The apparatus of claim 1, wherein the retainer comprises a magnet to provide a magnetic force to retain the stylus.

5. The apparatus of claim 1, further comprising heat stakes, wherein:
the retainer comprises:
a first material to form a tube to hold the stylus; and
a second material to attach to the first material, the second material comprising openings; and
the heat stakes extend from the substrate through the openings to secure the second material to the substrate.

6. The apparatus of claim 1, wherein the retainer comprises a retention member to contact the computing device to retain the substrate inside the slot connector.

7. A method comprising:
attaching a stylus holder to a card substrate; and
using the stylus holder to retain a stylus to a computing device when the card substrate is inserted in a smart card slot connector of the computing device.

8. The method of claim 7, further comprising:
providing a memory attached to the card substrate to store a digital certificate to authenticate a user of the computing device.

9. The method of claim 7, further comprising:
attaching a memory and a microprocessor to a portion of the substrate; the portion of the substrate being inserted into the smart card slot connector.

10. The method of claim 7, further comprising:
integrating the stylus holder and card substrate together from a single material.

11. An apparatus comprising:
a computing device comprising a microprocessor, a memory and a slot connector; the slot connector comprising first electrical contacts;
a card assembly comprising a substrate, a memory to store data representing a digital certificate, a microprocessor and second electrical contacts to physically contact the first electrical contacts when the card is received in the slot connector to communicate the data representing the digital certificate with the microprocessor of the computing device; and
an assembly to hold a stylus, the assembly being attached to the substrate.

12. The apparatus of claim 11, wherein the assembly comprises:
a first material to form a tube to hold the stylus;
a second material to attach to the first material; and
an adhesive to secure the second material to the substrate.

13. The apparatus of claim 12, wherein the first material comprises a polyurethane and the second material comprises a microfelt.

14. The apparatus of claim 11, wherein the assembly comprises:
a card substrate comprising curved members to form part of a tube to hold the sylus; and
a curved member to attach to the curved members of the substrate to form another part of the tube.

15. The apparatus of claim 11, further comprising a detent to provide a retention force to resist removal of the card substrate from the slot connector.
